(19) United States
(12) Patent Application Publication
(10) Pub. No.: US 2022/0237639 A1
(43) Pub. Date: Jul. 28, 2022

(54) SYSTEM AND METHOD FOR DATA PREDICTION USING HEAT MAPS

(71) Applicant: Wells Fargo Bank, N.A., San Francisco, CA (US)

(72) Inventor: Gerardo Costilla, San Francisco, CA (US)

(21) Appl. No.: 15/679,852

(22) Filed: Aug. 17, 2017

(51) Int. Cl. G06Q 30/02; G07F 19/00

(52) U.S. Cl. CPC G06Q 30/0205; G06Q 40/02; G07F 19/20

(57) ABSTRACT

Systems for predicting cash demand within a geographic region using various electronic resources is provided. In an example, a non-transitory, machine-readable medium, comprising instructions, which when performed by a machine, causes the machine to perform operations to receive cash information from one or more databases, and create a predictive cash demand map for a time period using the cash information.

### TECHNICAL FIELD

Embodiments described herein generally relate to data analysis and in particular, but without limitation, to techniques for prediction using heat maps.

### BACKGROUND

Automatic teller machines (ATMs) can provide a number of services to clients of the institutions that contract with ATM owner or who own the ATMs. ATMs can also provide limited services to non-client users. Many people use ATMs to procure cash when they are out and about. However, ATMs can be difficult to locate or may not be conveniently located at certain times for example, during large events, especially events that rely on a temporary venue where ATMs are not normally located.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates generally a system for predicting and satisfying cash demand.

FIG. 2A illustrates generally a predictive heat map plot of population for a geographic location during a time interval.

FIG. 2B illustrates generally a predictive heat map plot of people needing cash for a geographic location during a time interval.

FIG. 2C illustrates generally a predictive overlay of the heat map plots of FIGS. 2A and 2B.

FIG. 3 illustrates generally an example user interface for locating an ATM.

FIG. 4 illustrates generally an alternative user interface for locating an ATM.

FIG. 5 illustrates generally a flowchart of an example method of predicting and optionally satisfying cash demand.

FIG. 6 is a block diagram illustrating a machine in the example form of a computer system within which a set or sequence of instructions may be executed to cause the machine to perform any one of the methodologies discussed herein, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

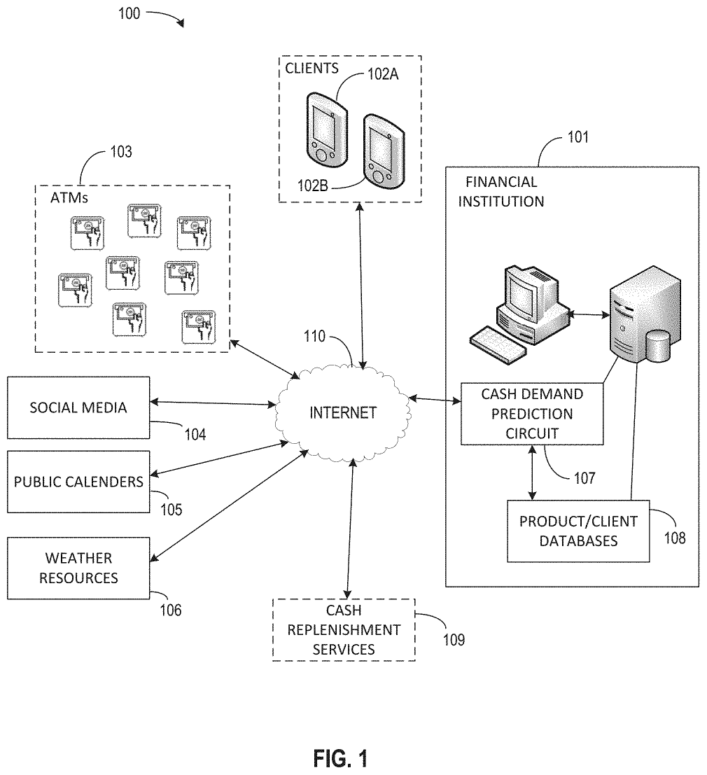

The present inventors have recognized techniques for predicting and dealing with cash demand in a geographic location. FIG. 1 illustrates generally a distributed system 100 for predicting cash demand in a location and for reacting to satisfy the predicted cash demand in the location. The distributed system 100 can include a company's computer system 101, for example, of a financial institution, electronic devices 102A, 102B of one or more user/customers, ATMs 103, online resources such as social media resources 104, public calendar resources 105, weather resources 106, etc., and one or more networks 110. In certain examples, the computer system 101 can include a cash demand prediction circuit 107 (e.g., a processing unit executing program code/instructions) that can communicate with the online resources 104, 105, 106, the ATMs 103 and the electronic devices 102A, 102B. The cash demand prediction circuit 107 can also access product and client databases 108 of the computer system 101.

The electronic device 102A can be mobile device (e.g., a mobile phone) that communicates with the computer system 101 via the network 110. For example, a user can install an application on their phone that is associated with the computer system 101. In another example, a third-party application can be used that communicates with the computer system 101. The application can present information related to ATMs as determined by the computing system 101 as discussed in more detail below. The electronic device 102A can include one or more sensors (e.g., gyroscope, accelerometer, global positioning system (GPS, camera). The sensors can be used, in conjunction with the information from the computer system 101, to present maps or an augmented reality view of an area by the user. In some examples, data from the sensors (e.g., GPS location of the electronic device 102A) can be transmitted to the computing system after receiving permission to transmit the data by the user.

In certain examples, the cash demand prediction circuit 107 can receive general information about future events from the online resources 104, 105, 106. For example, the online resources 104, 105, and 106 can provide public or private application programming interfaces (APIs). The cash demand circuit 107 can format an API call (e.g., an HTTP GET request) to one of the resources to retrieve the information. A server of one of the resources can process the API call and query one or more data stores to retrieve the requested information. The server can then format a response (e.g., in JavaScript Object Notation) with the requested information and transmit the response back to the cash demand prediction circuit 107. Additionally, the computer system 101 scan scrap data from the resources.

The general information about future events can provide insight for predicting future movement and location information for a population of people within a geographic location of interest. The online resources 104, 105, 106 can also assist in predicting spending amounts people in the geographic location will most likely spend during a future time interval. Such information can assist in predicting cash demand within the location and during the future time interval.

In certain examples, the cash demand prediction circuit 107 can access and receive historical client information from product and client databases 108 of for example, a financial institution. Historical client information can include information about transactions and products the client has made, purchased, used, etc. Historical client information received from the product and client databases 108 can provide insight into future locations of one or more clients within the geographic location of interest and during the future time interval. The product information received from the product and client databases 108 can provide historical, as well as, future spending information (e.g., a predicted dollar amounts) about the client population.

Spending information derived from the product and client databases 108 can also assist in predicting where clients of the financial institution will be located during a future time interval (e.g., between 1 and 3 PM on May 5). In certain examples, the spending information, as well as, a combination of the spending information and the information provided by the online resources can assist in predicting the amount of cash a client may currently possess during the future time period and within a geographic location. The spending information and events scheduled in the geographic location can assist in determining cash demand for the geographic location during the future time period.

For example, consider a user Alice that has an account with the financial institution. Based on this account, the computer system 101 can know how often Alice goes to an ATM, how much she regularly withdraws, what time of day she withdraws money, from which locations, etc. Additionally, the computer system may know how much money she spends at various types of events. In other words, the computer system 101 can predict an average likelihood she will go to an ATM given a location, time, current cash amount, etc. (e.g., using a regression analysis or other statistical technique).

Additionally, the computer system 101 can process data received from the online resources to determine the existence of a past event or future event. For example, natural language processing can be used on social media posts to determine a location, name, and data of an event. In other examples, an API can be provided by the social network to retrieve event data. Similarly, public calendar(s) on websites can be scrapped to determine events. Event data can also include the number of people indicated as going to the event (e.g., as determined by a social network).

In some examples, the ATMs 103 can provide ATM information to the cash demand prediction circuit 107. The ATM information can include, but is not limited to, diagnostic information, location information, wait time (e.g., counting the number of people in a line using facial recognition), cash reserves, or combinations thereof.

Given the above ATM information, one or more models can be developed to predict where money is likely to be needed in the future. For example, a neural network may be trained using historic ATM information, as well as other historic inputs correlated to the money level of an ATM at a given time, not limited to, whether an event is occurring, the amount of people in a region (e.g., using GPS or social media signals), the current amount of cash each person has (e.g., based on historic draw rates), the density of people in a region, etc. The output of the neural network may be a confidence level that an ATM or particular geographic region is going to run out of money at a particular time. Although a neural network is described, other artificial intelligent or deep machine learning methodologies may be used (e.g., k-nearest neighbor, support vector machines, etc.).

In certain examples, the cash demand prediction circuit 107 can generate heat map information for the geographic location during the future time period that indicates one or more parameters associated with cash demand (e.g,. using the output of machine learning model). In certain examples, the cash demand prediction circuit 107 can further process the heat map information to develop a plan for locating the ATMs 103 within the geographic location during the future time period such that the company's customers, as well as, others can have convenient access to cash.

In certain examples, the heat map information can be developed to show predictive movement of people and cash demand for the geographic area for an extended interval of time that can include the future time period. Such heat map information can be used to develop a plan for moving ATMs 103 during the extended interval such that the ATMs 103 continue to be located in convenient locations relative to where customers or others are predicted to need access to cash or other services.

In certain examples, the cash demand prediction circuit 107 can automatically dispatch ATMs 103 to the geographic location in preparation for satisfying the predicted cash demand in the geographic area of interest during the future time interval. In some examples, the cash demand prediction circuit 107 can transmit command information to autonomous ATMs. In response to the command information, one or more autonomous ATMs can schedule and execute moves to commanded locations within the geographic location both before and during the future time period or future extended interval to satisfy the predicted cash demand.

In certain examples, the cash demand prediction circuit 107 can model ATM usage and can develop a replenishment plan to prepare an ATM 103 for use during the future time period or extended interval or to provide replenishment of cash reserves of the ATM 103 during the future time period or during the extended interval. In certain examples, the cash demand prediction circuit 107 can use the heat map information to set up one or more replenishment centers 109 in or near the geographic location to satisfy cash demand during the future period or extended interval. A replenishment center can be a location where ATMs are prepared for service or where ATMs can be replenished with cash. Replenishment centers 109 can be a centrally located with respect to predicted cash demand within the geographic location. In certain examples, the cash demand prediction circuit 107 can determine a location and dispatch a replenishment center 109 such that autonomous ATMs can easily and quickly move to the replenishment center 109, replenish cash supplies and relocate to a location convenient for people needing access to cash within the geographic location.

In some examples, the ATMs 103 can provide ATM information to the cash demand prediction circuit 107. The ATM information can include, but is not limited to, diagnostic information, location information, wait time (e.g., counting the number of people in a line using facial recognition), cash reserves, or combinations thereof. In such examples, the cash demand prediction circuit 107 can provide application data for display to electronic devices 102 of customers or other people within the geographic location to assist the electronic device user in locating an ATM 103 or determine which ATM of a plurality of reasonably close ATMs will most likely be able to provide cash in a timely manner.

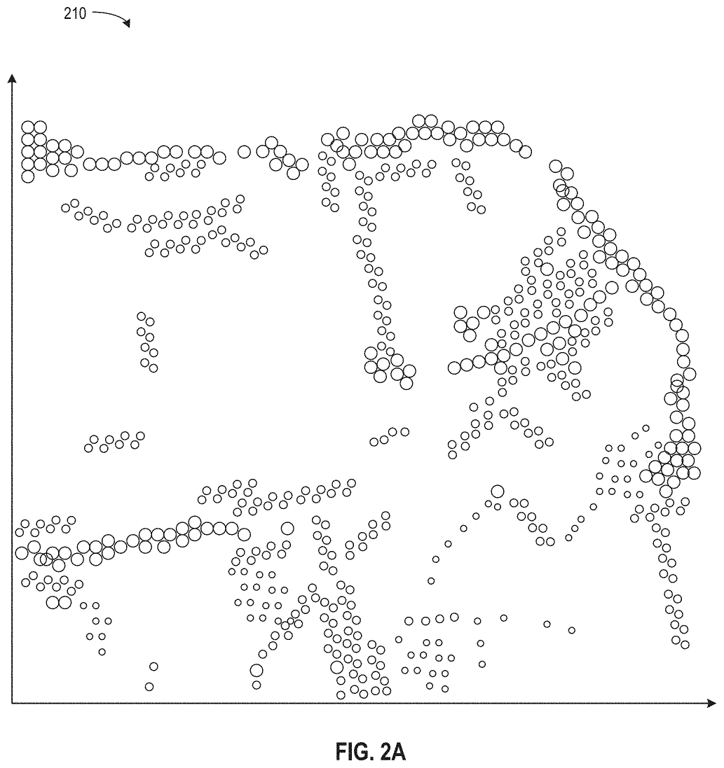

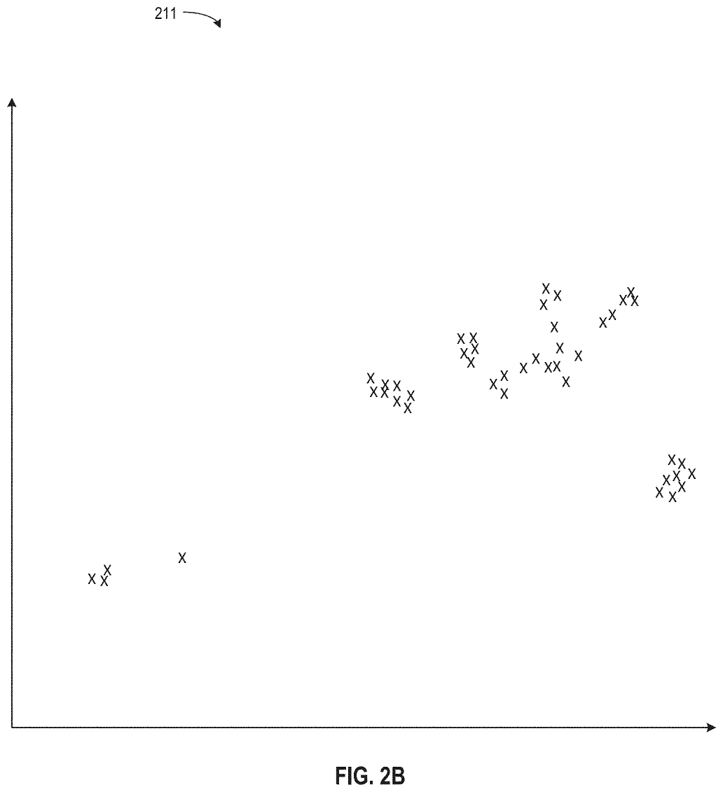

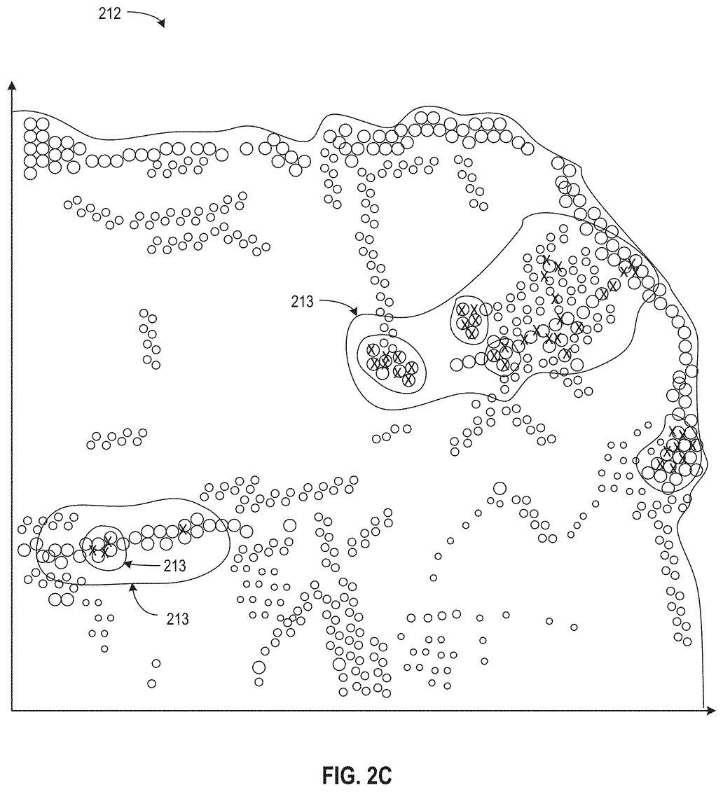

FIG. 2A illustrates generally a predictive heat map plot 210 of population for a geographic location during a future time interval or during a particular time period during a future extended time interval. In certain examples, the cash demand prediction circuit 107 can access one or more online resources to collect data for activites happening in the future within a geographic location. Some online resources can provide historical data about ambient population movement and spending within the geographic area. Such ambient information can include information about the distribution of spending between cash and other forms of payment. One or more online resources can also provide information about events that tend to gather large crowds of people and the location and time of these events. Such events can include sporting events, conventions, industry shows (e.g., hunting, camping, garden, boat, RV, etc.), concerts, rallies, protests, festivals, parades, etc. In certain examples, the online resources can provide historical spending information associated with the events. In some examples, one or more online resource can provide information that may influence attendance or movement of people within the geographic location during the future time interval of interest. Such resources can include weather resources, traffic or road construction resources, resources providing information about events happening outside the geographic location, etc.

Upon receiving the above information, the cash demand prediction circuit 107 can process the information for a particular time period and provide population heat map data or a set of population heat map data to show the predicted location of people within the geographic area of interest during a future time interval. FIG. 2A illustrates an example heat map for a particular future moment in time within a geographic location of interest. Location of people, amount of spending, or the amount of cash spending may be represented by the size and location of the individual plotted points (O).

FIG. 2B illustrates generally a predictive heat map plot 211 of people needing cash for a geographic location during a future time interval. In certain examples, the cash demand prediction circuit 107 can use the population heat map data, spending data collected from online resources and product and transaction information from the company's databases to predict how many people who might need cash will be within the geographic area and, in certain examples, where (X) those people will be. In some examples, the cash demand prediction circuit 107 can provide prediction information that identifies where the people who need cash, within the geographic location, will be at multiple different times within a future time interval. In certain examples, the predictive heat map plot 211 may only contain customer/clients of the company that owns or operates the cash demand prediction circuit or the associated product and transaction databases.

FIG. 2C illustrates generally a predictive overlay 212 of the heat map plots 210, 211 of FIGS. 2A and 2B. In certain examples, the data represented in the heat maps of FIGS. 2A and 2B can be overlaid on a map of the geographic area to provide cash demand heat map data for a particular moment within the future time period or interval of interest. In certain examples, the cash demand prediction circuit can determine concentrated areas of cash demand from the heat map and can begin to develop a plan for placement of ATMs, replenishment centers or both ATMs and replenishment centers. Upon determination of locations for an ATM or a replenishment center, the cash demand prediction circuit can begin generating work orders, and scheduling messages to procure the ATMs and the replenishment centers at the determined locations at the future time period. In certain examples, the predictive cash demand heat map information provided by the cash demand prediction circuit can include gradient information where each gradient region 213 can correspond to a different level of cash demand. In certain example, when plotted, the gradient information can be represented by a different color such that regions having high levels of predicted cash demand for a future time period can be easily distinguished from regions having low levels of predictive cash demand.

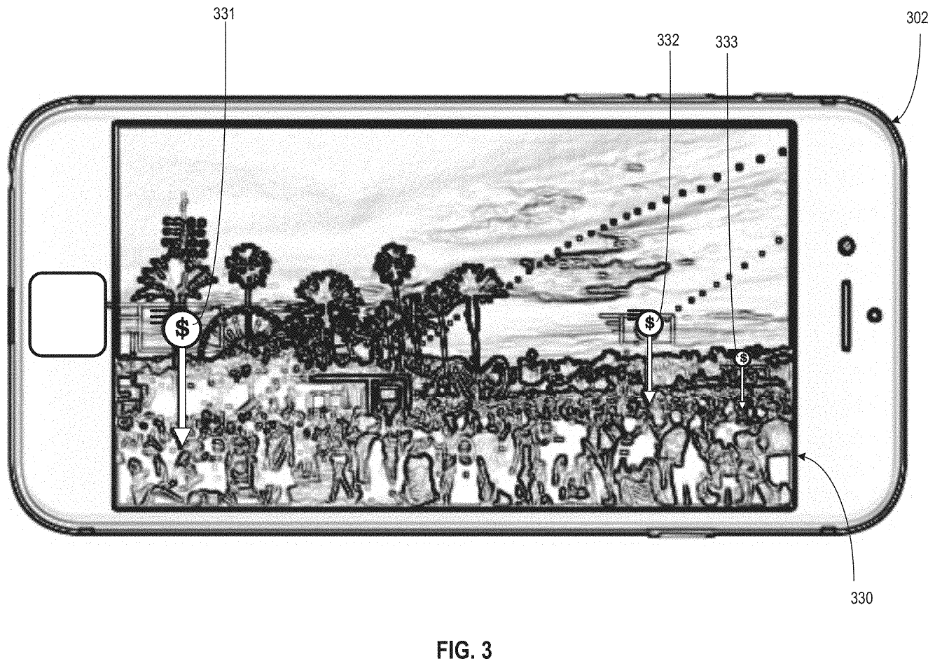

In certain examples, the cash demand prediction circuit can provide updated map information to assist a user in locating an ATM within the geographic area of interest. FIG. 3 illustrates generally a display 330 using the heat map information provided by the cash demand prediction circuit. In certain examples, display information upon which the display 330 is based can be utilized with the image representation from the camera of a mobile electronic device 302. In certain examples, the heat map information can be utilized in conjunction with global positioning system (GPS) data received from another source such as a GPS sensor of the mobile electronic device 302. In certain examples, the heat map information can assist a camera application with imposing ATM location images 331, 332, 333 as the camera image captures an image in the direction of the ATMs, in certain examples, the size of an ATM location image 331, 332, 333 can provide an indication of the distance to the particular ATM. in certain examples, a larger image can represent a closer ATM. In certain examples, other display characteristics can be used to convey information about a particular ATM. For example, color, brightness, or blinking characteristics can be used to display information about the distance to the ATM, the operational state of the ATM, the amount of cash reserves of the ATM, the wait time for the ATM, etc.

The wait time for an ATM can be estimated using sensors and historical data from the ATM. For example, a camera sensor can detect the number of people in the vicinity of the ATM. The ATM can access historic data indicating an average amount of time per person spends at an ATM to estimate a total weight time given the number of people in proximity to the ATM.

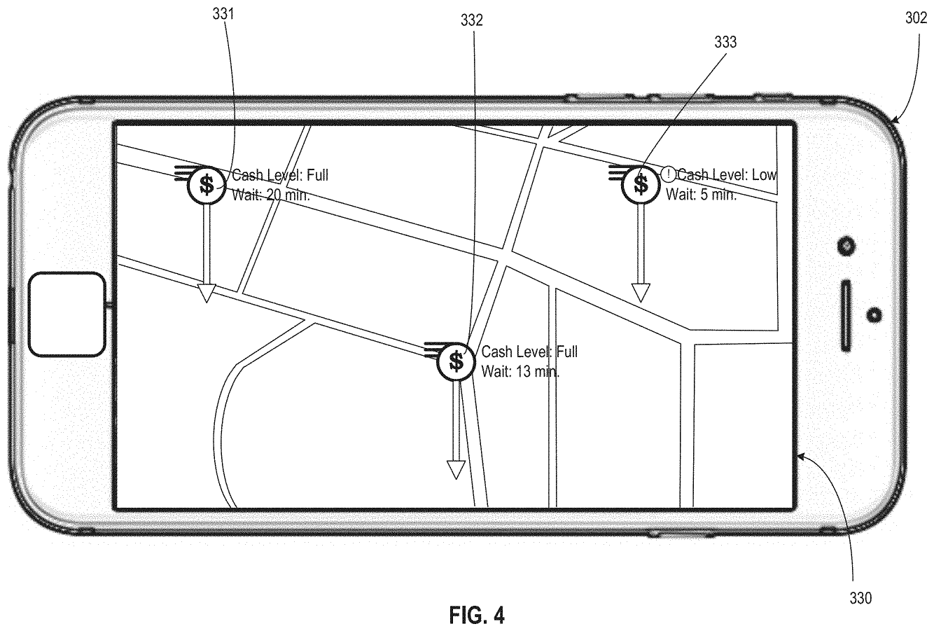

FIG. 4 illustrates generally a display 430 using the heat map information provided by the cash demand prediction circuit. In certain examples, display information upon which the display 430 is based can be utilized with a map display of a map application of a mobile electronic device 402. In certain examples, the heat map information can be utilized in conjunction with global positioning system (GPS) data received from another source such as a GPS sensor of the mobile electronic device 302. In certain examples, the heat map information can assist a map application with displaying ATM location images 431, 432, 433 as the map image captures the location of the ATMs. In certain examples, an ATM location image 431, 432, 433 can be accompanied by additional information about the ATM such as cash reserves of the ATM and wait time for using the ATM. In certain examples, other display characteristics can be used to convey information about a particular ATM. For example, color, brightness, or blinking characteristics can be used to display information about the relative distance to the ATM from the electronic device, the operational state of the ATM, the amount of cash reserves of the ATM, the wait time for the ATM, etc.

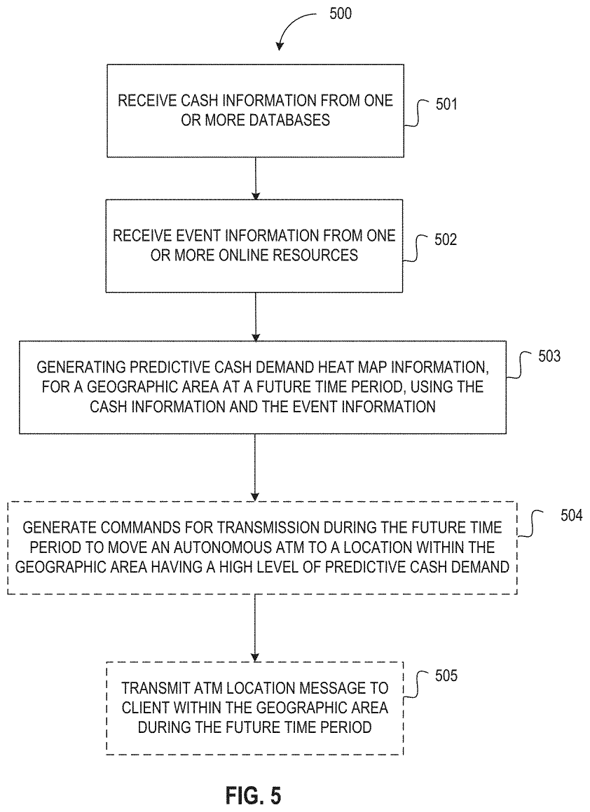

FIG. 5 illustrates generally a flowchart of an example method for operating a system including a predictive cash demand circuit. At 501, the predictive cash demand circuit can receive cash information from one or more databases. In certain examples, the predictive cash demand circuit can access the product and transaction data bases of a financial institution. Such data bases can include historical information indicative of the cash spending habits of the financial institutions clients. The can provide an indication of where a client may be located at a future period in time and how much cash the client will be carrying and how much cash the client may spend if the client had access to enough cash.

At 502, the predictive cash demand circuit can receive event information from one or more online resources. I certain examples, the predictive cash demand circuit can request and receive event information for a certain geographic location. The event information can be used to predict the amount of people in the geographic location at various future time intervals and the location of the people during the various future time intervals.

At 503, the predictive cash demand circuit can generate predictive cash demand heat map information, for a geographic area at a future time period, using the cash information and the event information. In certain examples, the predictive cash demand circuit can use the event information and the cash information to analyze the spending habits of a population within a certain geographic area during a future time interval. The analysis can use historical transaction information and historical attendance and revenue information for similar events scheduled during the future time period to predict how many people will be within a certain geographic area a certain time, how the people will migrate about the geographic area, how much cash will be spent within the geographic area, and how much cash people will want access to during the period and where the people wanting access to cash will be during the period.

In some examples, at 504, the predictive cash demand circuit can optionally generate commands to move an autonomous ATM to a location within the geographic area having a high level of predictive cash demand compared to other areas within the geographic area.

In certain examples, at 505, the predictive cash demand circuit can optionally transmit an ATM location message to a client within the geographic location during the future time period.

Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may include hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

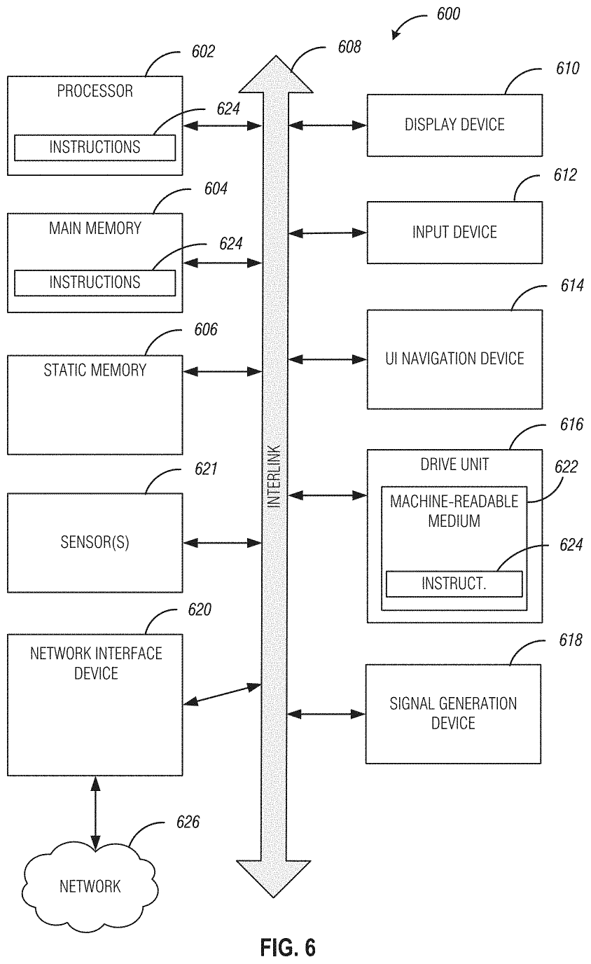

FIG. 6 is a block diagram illustrating a machine in the example form of a computer system 600, within which a set or sequence of instructions may be executed to cause the machine to perform any one of the methodologies for assisting a user in setting up and complying with one or more goals as discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc), a main memory 604 and a static memory 606, which communicate with each other via a link 608 (e.g., bus). The computer system 600 may further include a video display unit 610, an alphanumeric input device 612 (e.g., a keyboard), and a user interface (III) navigation device 614 (e.g., a mouse). In one embodiment, the video display unit 610, input device 612 and UT navigation device 614 are incorporated into a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., 6G, and 4G UTE/LIE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

1. A non-transitory, machine-readable medium, comprising instructions, which when performed by a processor of a machine, causes the processor to perform operations to:
receive cash infoiniation from a database, the database including client information for a financial institution;
scrape data from websites;
perform natural language processing on the scraped data to determine receive event information for a geographic region;
create a cash demand heat map for a future time period using the cash information and the event information, the cash demand heat map including a plurality of gradient regions, wherein each gradient region is indicative of a level of cash demand and the cash demand heat map corresponds to the geographic region;
process the cash information and the event lformation to predict a first ocation of a client of the financial institution during the future time period; and
provide cash procurement locations to a user device based on a global positioning system (GPS) location associated with the user device, wherein location images of the cash procurement locations and the cash procurement information are superimposed on the user device displaying the GPS location associated with the user device and the cash procurement information includes a cash reserve superimposed at each of the cash procurement locations and a size of the location images varies with a distance of the cash procurement locations to the user device.

2-4. (canceled)

5. The machine-readable medium of claim 1, including instructions to cause the processor to perform operations to schedule transmission of a digital message to the client during the future time period.

6. The machine-readable medium of claim 1, including instructions to cause the processor to perform operations to process the cash information and the event information to determine desired locations of automatic teller machines (ATMs) within the geographic location and during the future time period to meet a predicted cash demand.

7. (canceled)

8. The machine-readable medium of claim 6, including instructions to cause the processor to perform operations to generate commands to move additional ATMs to the desired locations of the ATMs before or during the future time period.

9. (canceled)

10. The machine-readable medium of claim 1, including instructions to cause the processor to perform operations to:
process the cash information to predict cash reserves of an ATM within the geographic region during the future time period; and
generate a command to replenish the cash reserve of the ATM before or during the future time period.

11. The machine-readable medium of claim 1, including instructions to cause the processor to perform operations to process the cash information and the event information to determine one or more central locations to provide a replenishment center within the geographic region during the future time period.

12. The machine-readable medium of claim 11, including instructions to cause the processor to perform operations to transmit coordinates of the one or more central locations to one or more ATMs within the geographic location.

13. The machine-readable medium of claim 1, including instructions to cause the processor to perform operations to process the cash information and the event information to predict a location of a client during the future time period to provide a predicted client location.

14. The machine-readable medium of claim 13, wherein the plurality of gradient regions includes a first gradient region having a first cash demand level and a second gradient region having a second cash demand level; and
wherein the second cash demand level is greater than the first cash demand level.

15. The machine-readable medium of claim 14, including instructions to cause the processor to perform operations to transmit a message during the future time period to the client.

16. (canceled)

17. A method for predicting and satisfying cash demand, the method comprising:
receiving, at a processor, cash information from a database, the database including client information for a financial institution;
scraping data from websites:
performing natural language processing on the scraped data to determine event information for a geographic region;
creating, at the processor, a cash demand heat map for a future time period using the cash information and the event information, the cash demand heat map including a plurality of gradient regions, wherein each gradient region is indicative of a level of cash demand and the predictive cash demand heat map corresponds to the geographic region;
processing the cash information and the event information to predict a first location of a client of the financial institution during the future time period; and
providing cash procurement locations to a user device based on a global positioning system (GPS) location associated with the user device, wherein location images of the cash procurement locations and the cash procurement information are superimposed on the user device displaying the GPS location associated with the user device and the cash procurement information includes a cash reserve superimposed at each of the cash procurement locations and a size of the location images varies with a distance of the cash procurement locations to the user device.

18. (canceled)

19. (canceled)

20. The method of claim 17, including schedu g transmission of a digital message to the client before or during the future time period,

21. The method of claim 17, including processing the cash info' enation and the event information to determine desired locations of first ATMs within the geographic location and during the future time period to meet a predicted cash demand.

22. A system comprising:
processing circuitry; and
a memory device including instructions embodied thereon, wherein the instructions, which when executed by the processing circuitry, configure the processing circuitry to perform operations that:
receive cash information frons a database;
scrape data from websites;
perform natural language processin on the scraped data to determine event information for a geographic region;
create and display a cash demand heat map for a future time period using the cash information and the event information, the cash demand heat map including a plurality of gradient regions, wherein each gradient region is indicative of a level of cash demand and wherein the cash demand heat map corresponds to a geographic region;
process the cash information and the event information to predict a first location of a client of a financial institution during the future time period;
process the cash information to predict a first amount of cash the client will have during the future time period;
schedule transmission of a first message to the client before or during the future time period; and
process the cash information to determine desired locations of first ATMs within the geographic location and during the future time period to meet the predicted cash demand;
process the cash information to predict cash reserves of an ATM within the geographic region during the future time period, and if the cash reserve is below a threshold, to generate a command to replenish the cash reserve of the ATM before or during the future time period; and
provide cash procurement locations to a user device based on a global positioning system (GPS) location associated with the user device, wherein location images of the cash procurement locations and the cash procurement information are superimposed on the user device displaying the GPS location associated with the user device and the cash procurement information includes a cash reserve superimposed at each of the cash procurement locations and a size of the location images varies with a distance of the cash procurement locations to the user device.

24. The system of claim 22, wherein the instructions, which when executed by the processing circuitry, configure the processing circuitry to perform operations that process the cash information to determine one or more central locations to provide a replenishment station within the geographic region during the future time period.

24. The system of claim 23, wherein the instructions, which when executed by the processing circuitry, configure the processing circuitry to perform operations that transmit coordinates of the one or more central locations to one or more ATMs within the geographic location.

25. The system of claim 22, wherein the instructions, which when executed by the processing circuitry, configure the processing circuitry to perform operations that:
process the cash information to predict a location of a client during the time period to provide a predicted client location, wherein the plurality of gradient regions includes a first gradient region having a first cash demand level and a second gradient region having a second cash demand level, and wherein the second cash demand level is greater than the first cash demand level.
